(19) United States
(12) Patent Application Publication
(10) Pub. No.: US 2026/0186510 A1
(43) Pub. Date: Jul. 2, 2026

(54) MANAGEMENT SYSTEM AND MANAGEMENT METHOD

(71) Applicant: TOYOTA JIDOSHA KABUSHIKI KAISHA, Toyota-shi (JP)

(72) Inventors: Yoshiki UEDA, Toyota-shi (JP); Osamu TANIAI, Toyota-shi (JP); Shiro ODA, Toyota-shi (JP)

(73) Assignee: TOYOTA JIDOSHA KABUSHIKI KAISHA, Toyota-shi (JP)

(21) Appl. No.: 19/378,375

(22) Filed: Nov. 4, 2025

(30) Foreign Application Priority Data
Dec. 27, 2024 (JP) 2024-231745

(51) Int. Cl. G05D 1/69; G05D 1/229; G05D 1/648; G05D 107/60

(52) U.S. Cl. CPC G05D 1/69; G05D 1/2295; G05D 1/648; G05D 2107/65

(57) ABSTRACT

A management system according to the present embodiment is a management system including a server managing a plurality of autonomous moving bodies that move within a facility, and includes a map information storage unit storing map information indicating a map of the facility, an area setting unit setting a restricted area on the map to restrict passage of the autonomous moving bodies, a right-of-way granting unit granting, to the autonomous moving bodies, a right-of-way that enables the autonomous moving bodies to pass through the restricted area, an order-of-priority setting unit granting an order of priority for passage by the autonomous moving bodies granted the right-of-way, and an updating unit that, when the right-of-way is newly granted to one autonomous moving body, updates the order of priority already granted. An AI model generated by machine learning such as supervised learning or the like may be used for area setting.

### CROSS-REFERENCE TO RELATED APPLICATION

This application claims priority to Japanese Patent Application No. 2024-231745 filed on Dec. 27, 2024. The disclosure of the above-identified application, including the specification, drawings, and claims, is incorporated by reference herein in its entirety.

### BACKGROUND

### 1. Technical Field

The present disclosure relates to a management system and a management method.

### 2. Description of Related Art

Japanese Unexamined Patent Application Publication No. 2024-17484 (JP 2024-17484 A) discloses a management system for managing passage of moving bodies that autonomously move. This system manages resources necessary for the passage of the moving bodies. The system grants resources in response to requests from the moving bodies. Further, a building is divided into a plurality of sub-areas, and resources are granted to each of the sub-areas.

### SUMMARY

In such a management system for moving bodies, there is demand for managing a plurality of moving bodies in a simple manner, such that the moving bodies can move efficiently.

A management system according to the present embodiment is a management system that is equipped with a server that manages a plurality of autonomous moving bodies that moves within a facility, includes a map information storage unit that stores map information indicating a map of the facility, an area setting unit that sets a restricted area on the map to restrict passage of the autonomous moving bodies, a right-of-way granting unit that grants, to the autonomous moving bodies, a right-of-way that enables the autonomous moving bodies to pass through the restricted area, an order-of-priority setting unit that grants an order of priority of passage for the right-of-way granted by the right-of-way granting unit, and an updating unit that, when the right-of-way is newly granted to one autonomous moving body, updates the order of priority already granted. A management method according to the present embodiment is a management

method for managing a plurality of autonomous moving bodies that moves within a facility, using a management device that includes a map information acquisition unit that acquires map information indicating a map of the facility and an area setting unit that sets a restricted area on the map to restrict passage of the autonomous moving bodies, includes granting, to the autonomous moving bodies, a right-of-way that enables the autonomous moving bodies to pass through the restricted area, setting an order of priority for passage by the autonomous moving bodies to which the right-of-way has been granted, and updating the order of priority already granted when the right-of-way is newly granted to one autonomous moving body.

According to the present disclosure, a management system and a management method that can manage moving bodies so as to move efficiently can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an overall configuration of a management system according to an embodiment;

FIG. 2 is a block diagram illustrating a control system of a management device;

FIG. 3 is a diagram illustrating restricted areas and waypoints set in map information of a facility;

FIG. 4 is a diagram illustrating restricted areas and waypoints set in map information of the facility;

FIG. 5 is a flowchart showing a management method; and

FIG. 6 is a table showing correlation between waypoint attributes and actions.

### DETAILED DESCRIPTION OF EMBODIMENTS

The present disclosure will be described below by way of an embodiment of the disclosure, but the disclosure according to the claims is not limited to the following embodiment. Also, not all of the configurations described in the embodiment are necessarily essential means for solving the problems.

### Overall Configuration

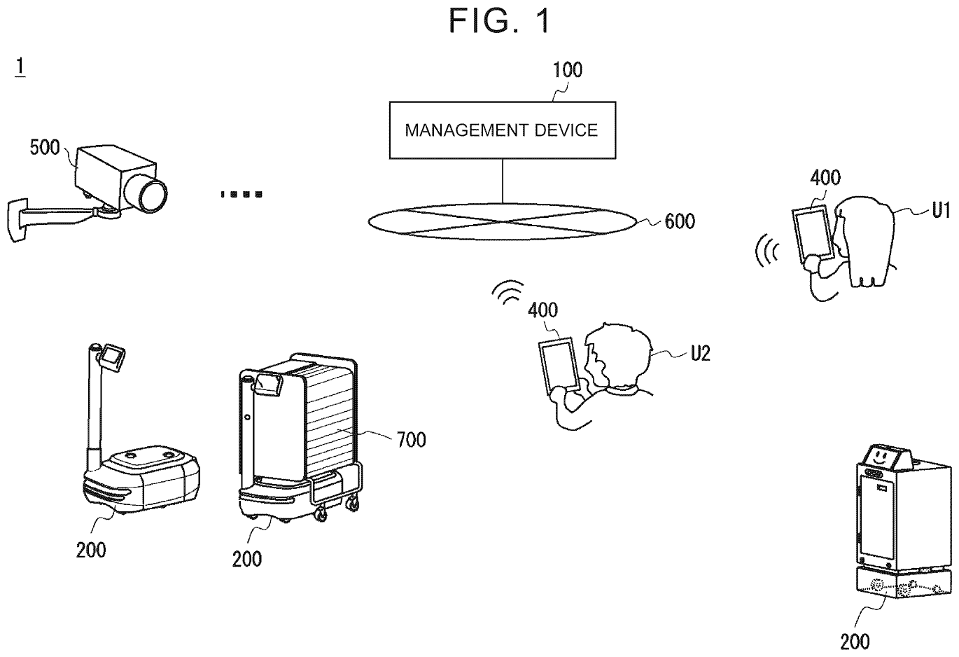

A management system according to the present embodiment is a system for managing autonomous moving bodies. FIG. 1 is a schematic diagram illustrating a configuration of a management system 1. The management system 1 is a system for managing a plurality of robots 200, and the management system 1 includes a management device 100, the robots 200, a camera 500, a network 600, user terminals 400, and an accessory unit 700. The management device 100 manages passage and tasks of the robots 200.

The robots 200 are autonomous moving bodies that carry out tasks such as transporting tasks and so forth. The robots 200 move autonomously in medical and welfare facilities such as hospitals, rehabilitation centers, nursing homes, elderly care facilities, and so forth. The robots 200 are used to transport medications, medical equipment, meals, tableware, medical records, supplies, samples, linens, people, and so forth. The object to be transported may be a person such as a patient or the like. Also, the system according to the present embodiment can also be used in commercial facilities and so forth, such as shopping malls and so forth. Each of the robots 200 has wheels, a chassis, a motor, a sensor, a battery, a controller, and so forth. At least one of the robots 200 is a different type of robot. The robots 200 may all be the same type of robot. Each of the robots 200 is assigned a unique identification number (ID). Although three robots 200 are illustrated in FIG. 1, the number of robots is not limited in particular, as long as there is a plurality of the robots. Further, at least one of the robots 200 may carry out a task other than the

transporting tasks. Other tasks include cleaning tasks, security tasks, guiding tasks, and so forth. The robots 200 may use the accessory unit 700 to carry out a plurality of the tasks, such as cleaning, security, guiding, and so forth, or may carry out tasks alone. The robots 200 can carry out various types of tasks by the robots 200 being used in combination with the accessory unit 700, for example. The robots 200 may be equipped with different accessory units depending on the tasks. Replacing the accessory unit 700 enables the robots 200 to become multitasking robots that carry out multiple tasks.

In the case of a transporting task, the accessory unit 700 is a wheeled cart or wagon on which transported items are loaded. For a cleaning task, the accessory unit 700 has a vacuum cleaner that sucks up dust and the like. For security tasks, the accessory unit 700 has sensors such as a LiDAR (short for Light Detection And Ranging) device, cameras, and so forth. In the following description, the robots 200 will be described as mainly carrying out transporting tasks.

A user U1 or a user U2 can use the user terminals 400 to place a task request, such as a transporting request for a transported item, or the like. The user terminals 400 are, for example, a tablet computer, a smartphone, or the like. The user terminals 400 may be any information processing device that is capable of wireless or wired communication.

In the present embodiment, the robots 200 and the user terminals 400 are connected to the management device 100 via the network 600. The network 600 is a wired or a wireless local area network (LAN), or a wide area network (WAN). Further, the management device 100 is connected to the network 600 via a wired or a wireless connection. Communication that is compliant with general-purpose communications standards such as, for example, Wi-Fi (registered trademark) or the like, can be used for the communication among devices.

Various types of signals transmitted from the user terminals 400 of the users U1 and U2 are first sent to the management device 100 via the network 600, and then transferred from the management device 100 to the robot 200 that is intended. Similarly, various types of signals transmitted from the robot 200 are first sent to the management device 100 via the network 600 and then transferred from the management device 100 to the user terminal 400 that is intended. The management device 100 is a server connected to each piece of equipment and collects data from each piece of equipment. Also, the management device 100 is not limited to being a single physical device, but rather may include multiple devices that perform distributed processing. Also, the management device 100 may be placed distributed among edge devices such as the robots 200 or the like. For example, part or all of the management system 1 may be installed in the robots 200.

Each of the robots 200 has a drive motor, wheels, a battery, and so forth. Further, the robot 200 has sensors such as a camera and LiDAR device or the like, and a computation processing unit such as a processor or the like. The robot 200 estimates its own position based on detection results of the sensors. The robot 200 autonomously moves along a route from a departure point to a destination point on a map, based on its own position. The departure point is the current position of the robot, and the destination point is a transportation destination of the transported item. Also, a route search may be performed using a transportation origin or the like of the transported item as a transit point. Note that the management device 100 may perform a route search from the departure point to the destination point, or the robot 200 may perform a route search.

The user terminal 400 and the robot 200 may exchange signals without going through the management device 100. For example, the user terminal 400 and the robot 200 may directly exchange signals via wireless communication. Also, the management device 100 may also collect data from the camera 500. The camera 500 is a surveillance camera, a security camera, or the like. Furthermore, the management device 100 may collect data from communication equipment and sensors that are omitted from illustration.

It will be assumed that a plurality of types of the robots 200 is used in a facility. The management device 100 assigns tasks to each of the robots 200. Each of the robots 200 may be equipped with an accessory unit 700 according to the task that is assigned thereto, so as to carry out the task. The tasks to be carried out by the robot 200 may be input by the user U1 or the user U2, or may be scheduled in advance. For example, the user U1 or the like operates the user terminal 400 to place a task request. The user U1 or the like can input the type of task to be carried out. The user U1 or the like may input a region, a time slot, and so forth, in which the task is to be carried out. The management device 100 creates a schedule for the robot 200 to efficiently carry out tasks.

The user U1 or the user U2 may operate the user terminal 400 to request a transporting task. In this case, the user U1 or the user U2 inputs information regarding the transported item. Further, the user U1 or the user U2 may input arrival schedule information indicating the expected arrival time of the transported item. The management device 100 assigns a robot to carry out the transporting task based on expected arrival time information. The management device 100 then transmits a control signal for the robot to carry out the task. The control signal may include the route to the destination point, transported item information indicating the transported item, and so forth.

In such an overall configuration, the elements of the management system 1 can be distributed among the robots 200, the user terminals 400, and the management device 100, so as to construct the management system 1 as a whole. Also, the management system can be constructed by assembling all the essential elements for realizing transporting of the transported item into a single device.

### Control System

The management device 100 includes a server computer or the like, and performs computation for controlling and managing the robots 200. The management device 100 can be implemented as a device capable of executing programs, such as a central processing unit (CPU) or the like of a computer, for example. The functions described below can also be realized by a program. The management device 100 manages each of the transported items and the robots, based on transported item IDs of the transported items and robot IDs of the robots 200.

For example, the management device 100 manages schedules for the robots 200 such that the robots 200 can efficiently carry out tasks. For example, upon receiving a task request from the user terminal 400 or the like, the management device 100 selects one robot 200 from the robots 200, and instructs this robot 200 to carry out the task. Alternatively, the management device 100 instructs the robot 200 which of the accessory units 700 to use.

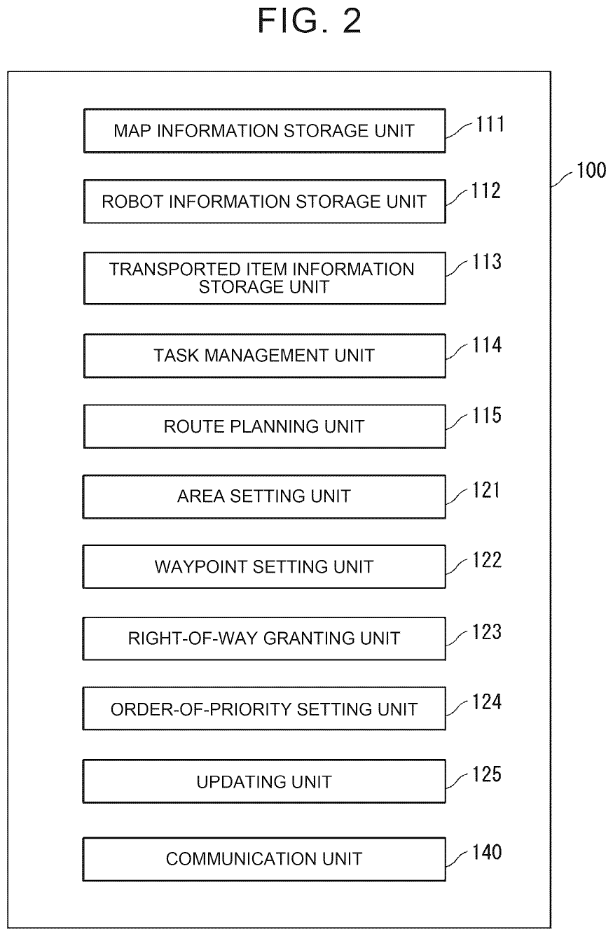

FIG. 2 is a block diagram illustrating a control system of the management device 100 according to the present embodiment. As illustrated in FIG. 2, the management device 100 includes a map information storage unit 111, a robot information storage unit 112, a transported item information storage unit 113, a task management unit 114, and a route planning unit 115. The management device 100 also includes an area setting unit 121, a waypoint setting unit 122, a right-of-way granting unit 123, an order-of-priority setting unit 124, an updating unit 125, and a communication unit 140. The functional blocks illustrated in FIG. 2 are an example, and the management device 100 may include other functional blocks. Alternatively, the management device 100 may not have some of the functional blocks illustrated in FIG. 2. Further, some functions may be performed on the robot 200 side.

The map information storage unit 111 stores map information that indicates a floor map (also simply referred to as “map”) of the facility. This map information may include information regarding restricted areas, waypoints, and so forth, which will be described later. The map information may be created in advance. Also, the map information may be map information that includes just part of a region in which a service is scheduled to be carried out, rather than a floor map of the entire facility. Each of the robots references the map information and travels autonomously to the destination point thereof. The map information may be generated based on architectural drawings, computer-aided design (CAD) data, building information modeling (BIM) data, or the like. Alternatively, the map information may be generated based on measurement results of a ranging sensor such as a LiDAR device or the like.

The robot information storage unit 112 stores robot information. The robot information includes information regarding the robots 200 operating in the facility. The robot information includes information regarding the model numbers of the robots 200, the services that can be carried out, the types of transported items that can be transported, the accessory units 700 that can be attached, and so forth. The robot information storage unit 112 stores the robot information as a database, in which various types of information is stored for each of the robot IDs. The robot information may include the current position of the robot, the movement path thereof, information indicating whether the robot is currently carried out a task or is at rest, and information regarding the task being carried out. The robot information may include information regarding the accessory unit in use and the transported item being transported.

The transported item information storage unit 113 stores transported items information relating to transported items. For example, the transported item information includes information such as the identification number (ID) of the transported item, contents of the transported item (type), the transportation origin, the transportation destination, the time of receipt, the time of arrival, and so forth. The transported item information is information indicating whether the transported item is medications, medical equipment, food, tableware, medical records, supplies, samples, linens, or people. The transported item information may include information such as size, weight, or the like of the transported item. The transported item information may include information indicating the status, such as in transport, before transport (before loading), transportation completed, or the like. The transported item information storage unit 113 stores transported item information as a database in which such information is associated with each of the transported item IDs. When a new transporting request for a transported item is made from the user terminal 400, the transported item information is added thereto. Also, after transportation is completed, the information regarding the transported item may be deleted from the list.

The task management unit 114 manages the tasks carried out by the robots 200. For example, the user U1 inputs transported item information, including the transported item, the transportation origin, the transportation destination, and so forth, and requests a transporting task. The task management unit 114 assigns the transporting task to a robot 200. For example, the task management unit 114 extracts robots that can carry out the task. For example, when some of the robots 200 are unable to transport the transported item of the contents regarding which the transporting request has been made, the task management unit 114 excludes those robots 200 and extracts the remaining robots 200.

The task management unit 114 extracts a robot 200 that can transport the transported item from among the robots 200. The task management unit 114 then assigns the transporting task to the robot 200 that is extracted. When there are two or more robots capable of transporting the transported items, the task management unit 114 selects a robot such that the transport service can be carried out more efficiently. For example, the task management unit 114 assigns the task to a robot located near the transportation origin. Alternatively, the task management unit 114 assigns the task to an idle robot that is not carrying out any other task. Thus, the task can be carried out efficiently.

The task management unit 114 manages tasks that have been carried out, tasks that are currently being carried out, and tasks that are scheduled to be carried out, by each of the robots 200. Further, the task management unit 114 may store various types of task information for each task, as a database. The task management unit 114 may store, as task information, information indicating whether each of the robots 200 is carrying out or has completed a task. Also, the task management unit 114 may also store, as task information, a transportation start time when the transportation is to begin, and an estimated end time when the task being carried out is to be completed. The task information may include transport information regarding the transported item being transported. For example, the task information may include information such as the type of the transported item, the transportation destination, the transportation origin, and so forth. Alternatively, the task management unit 114 may store information indicating whether the accessory unit 700 is in use.

The route planning unit 115 plans a route for carrying out the task. For example, the route planning unit 115 searches for a route from the transportation origin to the transportation destination for the robot 200 to which the task has been assigned. Specifically, a route from the current position of the robot 200 to the transportation origin is searched for. Note that the transportation origin is the location at which the transported item is to be loaded. Furthermore, the route planning unit 115 searches for a route from the transportation origin to the transportation destination.

Route searching uses waypoints set on the map. Waypoints are identified on the map as passing points over which the robot is to pass. Waypoints will be discussed later. The route searched by the route planning unit 115 is transmitted to the robot 200. Note that at least part of the processing of the route planning unit 115 may be carried out by the robot 200. Furthermore, when a congested region is identified based on images from a surveillance camera or the like, the route planning unit 115 may search for a route such that the congested region can be circumvented. The route planning unit 115 may search for a route that can be moved over in the shortest time, the shortest distance, or the like.

When waypoints corresponding to the departure point, destination point, and transit points are input, the route planning unit 115 performs a route search. Route searching identifies waypoints to pass and the order of passage. The communication unit 140 then transmits, to the robot 200, ID information and positions of the waypoints to be passed.

The area setting unit 121 divides the map into a plurality of areas. The area setting unit 121 sets restricted areas and non-restricted areas based on the areas. The area setting unit 121 sets restricted areas on the map. The restricted areas are regions in which the movement of the robot 200 is restricted. For example, restricted areas are regions that include intersections or forks. Alternatively, narrow passageways and so forth, where two-way traffic of robots 200 cannot be performed, are restricted areas. In order to pass through a restricted area, the robot 200 needs a right-of-way. That is to say, a robot 200 that is not granted a right-of-way cannot enter the restricted area and goes into standby just short of the restricted area. Note that on the map, regions other than the restricted areas are non-restricted areas. In non-restricted areas, robots 200 can pass through without a right-of-way. The area setting unit 121 sets one or a plurality of the restricted areas on the map. The area setting unit 121 also sets one or a plurality of the non-restricted areas on the map.

The area setting unit 121 assigns an area ID to each of the restricted areas and the non-restricted areas. The area setting unit 121 associates the area ID with boundary lines and boundary coordinates and performs storage thereof as area information. The area information may include information indicating attributes of the restricted areas and the non-restricted areas. For example, attributes include passageway, intersection, fork, elevator hall, hallroom, room, entrance/exit, goods receiving location, loading location, unloading location, standby location, charging location, and so forth. The area information may also include information indicating the number of robots that can pass through at the same time, and so forth. Restrictions on passage is not limited to limiting both-way traffic, and may also include one-way traffic, alternating single-lane traffic, and so forth. Also, the area setting unit 121 may change the area settings depending on the time of day or situations.

For example, the area setting unit 121 performs dividing such that each of the rooms is a different area. The area setting unit 121 then determines whether to set each room as a restricted area depending on the usage, size, placement, layout, and so forth of each room. The area setting unit 121 sets intersections, forks, and the like in the passageways as restricted areas. The area setting unit 121 sets areas other than intersections, forks, and the like as non-restricted areas. For example, the area setting unit 121 sets straight sections of the passageways as non-restricted areas.

Note that the management device 100 or another computer may set the restricted areas and the non-restricted areas through computation processing, or the user may perform setting thereof. Furthermore, following setting the restricted areas and/or non-restricted areas by computation processing, the user may manually adjust the area settings. For example, one or more restricted areas or one or more non-restricted areas may be set by a computer, such as the management device 100 or the like, executing a program. The user may manually set one or more restricted areas or one or more non-restricted areas.

Using a program for setting areas enables area settings to be easily performed. Specifically, the computer sections passageways and rooms based on architectural drawing data, map layout, and BIM data. Upon identifying an intersection, a fork, an entrance/exit, a standby location, a corner, a narrow passageway, or the like, the computer sets that location as a restricted area. To automatically set the area, an artificial intelligence (AI) model that is generated by supervised learning or the like can be used.

Image data of architectural drawings and BIM data are taken as input for a machine learning model. The machine learning model uses a segmentation algorithm to identify impassable locations such as walls, fixtures, and so forth, and to section rooms, passageways, and so forth. The machine learning model determines whether passage should be restricted and sets up restricted areas. For example, the machine learning model identifies narrow passageways, entrances/exits, standby locations, and forks and surrounding areas thereof, as restricted areas. The machine learning model defines areas on the map other than the restricted area as being non-restricted areas.

The area setting unit 121 may also set areas using an algorithm other than a model obtained by machine learning, as a matter of course. Alternatively, the traveling of the robot may be monitored after operating the robot. When a location where the robot readily becomes unable to pass is identified, the area setting unit 121 may set that location as a restricted area. Also, manual settings and automatic settings may be combined.

The waypoint setting unit 122 sets waypoints on the map. The waypoints are points over which the robot 200 passes. Waypoints are used in route planning. For example, the route planning unit 115 sets waypoints from the departure point to the destination point, and the order thereof. The route planning unit 115 decides the order of waypoints that are points to be passed. The robot 200 travels autonomously, passing over the waypoints in the order that is set. For example, when a passageway is divided at a fork or an intersection, the waypoint setting unit 122 appropriately sets waypoints at the fork, the intersection, a corner thereof, and surroundings thereof. The waypoint setting unit 122 also sets waypoints at boundary portions of the areas.

The waypoint setting unit 122 sets a plurality of waypoints on the map. The waypoint setting unit 122 assigns a waypoint ID to each of the waypoints. The waypoint setting unit 122 associates coordinates of the waypoints with the IDs thereof and performs storage thereof as waypoint information. The waypoint information may include attributes of the waypoints. The waypoint setting unit 122 may also set a charger, inside of an elevator, an elevator boarding and disembarking position, a goods receiving location, a goods loading location, and in front of an automatic door, as waypoints.

Note that waypoints may be set by the management device 100 or another computer through computation processing, or may be set by the user. Further, after the waypoints are set by computation processing, the user may manually adjust the waypoint settings. For example, one or more waypoints may be set by a computer such as the management device 100 or the like executing a program. The user may manually set the waypoints.

Using a program to set waypoints enables waypoints to be easily set. Specifically, when the computer identifies an intersection or the like based on architectural drawing data, map layout, CAD data, or BIM data, the waypoint setting unit 122 sets a waypoint at that location. Alternatively, the waypoint setting unit 122 sets waypoints at boundary portions between restricted areas and non-restricted areas. To automatically set waypoints, an AI model generated by supervised learning or the like can be used.

Image data of architectural drawings and BIM data are taken as input for the machine learning model. Further, map data in which areas has been set is taken as input for the machine learning model. The machine learning model sets waypoints using a segmentation algorithm. Also, manual settings and automatic settings may be combined.

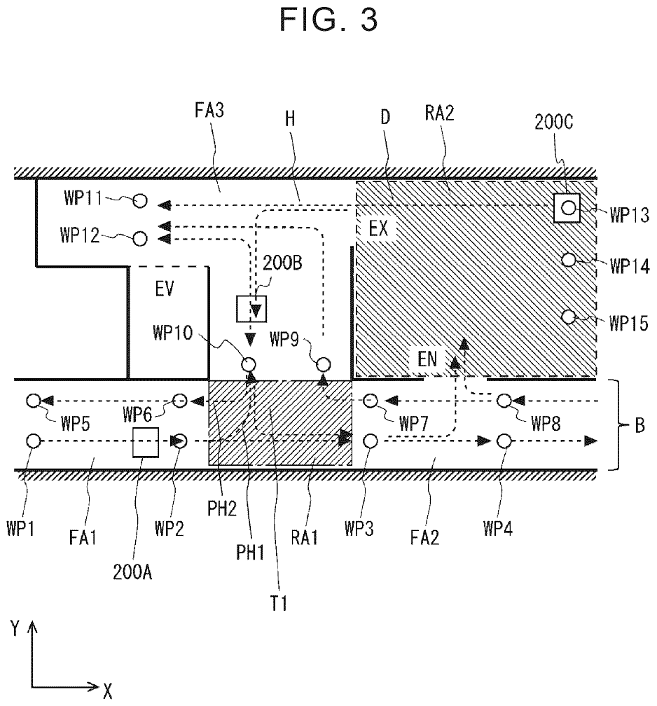

The restricted areas, non-restricted areas, and waypoints set on the map will be described with reference to FIG. 3. FIG. 3 is a plan view schematically illustrating a map. In FIG. 3, restricted areas RA1 and RA2, and non-restricted areas FA1, FA2, and FA3, are included on the map. For the sake of clarity of description, an XY two-dimensional orthogonal coordinate system is included in FIG. 3. Also illustrated in FIG. 3 are three robots 200, identified as robots 200A, 200B, and 200C. Also, when the robots 200A, 200B, and 200C are not to be distinguished from one another, they will be collectively referred to as robots 200.

In FIG. 3, a passageway B extending in an X direction is provided on a −Y side of the map. A fork T1, which is a three-way intersection, is provided partway along the passageway B. The passageway B is divided into the non-restricted area FA1, the restricted area RA1, and the non-restricted area FA2. The restricted area RA1 is placed between the non-restricted area FA1 and the non-restricted area FA2. The non-restricted area FA1 is placed on a −X side of the restricted area RA1, and the non-restricted area FA2 is placed on a +X side. In the restricted area RA1, the number of robots that can pass through at one time is restricted to one. The restricted area RA1 corresponds to the fork T1.

A hallroom H is placed on a +Y side of the restricted area RA1. The fork T1 is a path from the passageway B to the hallroom H. The hallroom H includes, for example, an elevator hall in which an elevator EV is installed. The restricted area RA1 corresponds to the fork at which the hallroom H and the passageway B connect. The hallroom H is in the non-restricted area FA3.

A dispensary D is placed on the +Y side of the non-restricted area FA2 and also on the +X side of the non-restricted area FA3. The dispensary D is a loading and unloading location. That is to say, the dispensary D is a room where transported items are loaded onto the robots, 200 or a room where goods are received from the robots 200. The dispensary D can also be said to be a standby location for standby to receive or load goods.

An entrance EN to the dispensary D is provided at a boundary portion of the non-restricted area FA2 and the restricted area RA2. The robots 200 enter the dispensary D from the passageway B through the entrance EN. The robots 200 are then loaded with transported items, such as medications. An exit EX from the dispensary D is provided at a boundary portion of the non-restricted area FA3 and the restricted area RA2. The robots 200 exit the dispensary D through the exit EX and into the hallroom H. The robots 200 then move to the transportation destinations thereof that are specified, while transporting the transported items.

In FIGS. 3, 15 waypoints WP1 to WP15 are set on the map. The waypoint setting unit 122 registers unique waypoint IDs for waypoints WP1 to WP15. Further, the waypoint setting unit 122 associates the waypoint IDs with X and Y coordinates on the map.

Waypoints WP1 to WP8 are set in the passageway B. Waypoints WP9 to WP12 are set in the hallroom H. Waypoints WP13 to WP15 are set in the dispensary D. Waypoints WP1, WP2, WP5, and WP6 are set in the non-restricted area FA1. Waypoints WP3, WP4, WP7, and WP8 are set in the non-restricted area FA2. Waypoints WP9 to WP12 are set in the non-restricted area FA3. Waypoints WP13 to WP15 are set in restricted area RA2. Note that while no waypoints are set in the restricted area RA1, waypoints may be set therein.

The passageway B is wide enough for the robots 200 to pass each other, and accordingly the waypoints are set in two rows. Description will be made here assuming that the robots 200 travel on the right side when passing through the passageway B. Waypoints WP1 to WP4 are passing points when traveling along the passageway B in a +X direction. Waypoints WP5 to WP8 are passing points when traveling along the passageway B in a −X direction. For example, when the planned route includes a path that proceeds along the passageway B in the +X direction, the route planning unit 115 plans the route such that the robot 200A passes waypoints WP1, WP2, WP3, and WP4, in this order.

The passageway B has a passage width that allows passage in both directions of the +X direction and the −X direction, and accordingly waypoints WP1 and WP5 are set at the same position in the X direction, but at positions offset in the Y direction. This allows two of the robots 200 to pass each other.

Waypoints WP2 and WP6 correspond to the fork in the passageway B. Accordingly, waypoints WP2 and WP6 are set on a boundary portion of the restricted area RA1 and the non-restricted area FA1. That is to say, waypoints WP2 and WP6 are set near a boundary line of the restricted area RA1 and the non-restricted area FA1. Here, waypoints WP2 and WP6 are set on the non-restricted area FA1 side of the boundary line of the areas.

Waypoints WP3 and WP7 correspond to the fork in the passageway B. Waypoints WP3 and WP7 are set on a boundary portion of the restricted area RA1 and the non-restricted area FA2. That is to say, waypoints WP3 and WP7 are set near a boundary line of the restricted area RA1 and the non-restricted area FA2. Here, waypoints WP3 and WP7 are set on the non-restricted area FA2 side of the boundary line of the areas.

Waypoints WP9 and WP10 correspond to the fork in the passageway B. Waypoints WP9 and WP10 are set on a boundary portion of the restricted area RA1 and the non-restricted area FA3. That is to say, waypoints WP9 and WP10 are set near a boundary line of the restricted area RA1 and the non-restricted area FA3. Here, waypoints WP9 and WP10 are set on the non-restricted area FA3 side of the boundary line of the areas.

Waypoints WP11 and WP12 correspond to standby positions for the elevator EV. Waypoint WP12 is set in front of the elevator EV. For example, when the robots 200 board the elevator EV, the route includes waypoint WP11 or waypoint WP12. The robots 200 then goes into standby until the elevator EV arrives at the waypoint WP11 or the waypoint WP12.

Waypoints WP13 to WP15 correspond to standby locations where transported items are loaded and unloaded. The robots 200 are in standby at waypoint WP13 or the like until loading of the transported items is completed. Alternatively, the robots 200 are in standby at waypoint WP13 or the like until the unloading of the transported items is completed.

Returning to the description of FIG. 2, the right-of-way granting unit 123 grants the robots 200 right-of-ways. A right-of-way is a resource that allows the robots 200 to pass through a restricted area. The right-of-way granting unit 123 grants a right-of-way to each of the robots. Further, the right-of-way granting unit 123 manages right-of-ways for each of the restricted areas.

The right-of-way granting unit 123 grants the right-of-way to the robots 200 in response to a request from the robots 200. For example, when the robot 200A arrives at or near waypoint WP2, the robot 200A transmits a request signal to the management device 100, to request right-of-way through the restricted area RA1. When the communication unit 140 of the management device 100 receives the request signal, the right-of-way granting unit 123 grants the robot 200A right-of-way through the restricted area RA1. Specifically, the communication unit 140 transmits a right-of-way granting signal to the robot 200A. The right-of-way signal includes the area ID and so forth of the restricted area through which passage is permitted.

Alternatively, the right-of-way granting unit 123 may determine whether to grant a right-of-way. When the robot 200A transmits its own position on the map to the management device 100, the right-of-way granting unit 123 determines whether the robot has arrived just short of the restricted area RA1. For example, when the robot 200A arrives at waypoint WP2, the robot 200A is granted right-of-way. Note that positions at which right-of-way is granted may be positions other than waypoints. Position coordinates of the position at which the right-of-way is granted may be set in advance. For example, when the robot 200 reaches a predetermined right-of-way granting position near a restricted area, the right-of-way granting unit 123 grants the robot 200 a right-of-way. In the following description, the right-of-way granting position is assumed to be the same position as the waypoint that is closest to the restricted area, but the right-of-way granting position may be set to different position coordinates from the waypoint.

The right-of-way granting unit 123 cancels the right-of-way once the robot 200 passes through the restricted area. For example, when the robot 200A passes through the restricted area RA1 and enters the non-restricted area FA2, the right-of-way granting unit 123 cancels the right-of-way of the robot 200A regarding the restricted area RA1. Alternatively, the robot 200A may send a signal for cancellation to the management device 100 based on its own position. Also, a waypoint for canceling the right-of-way may be set.

For example, assumption will be made that the route planning unit 115 is planning routes such that the robot 200A moves along a path PH1, and also that the robot 200B moves along a path PH2. In this case, in a situation in which the robot 200A and the robot 200B enter the restricted area RA1 at the same time, there is a risk that the robot 200A and the robot 200B will come face to face within the restricted area RA1. In this situation, the robot 200A and the robot 200B will be unable to pass through the restricted area RA1 or will need to make a detour. Accordingly, the restricted area RA1 is set up to restrict the passage of the robots 200. Thus, the robots 200 can move efficiently.

The order-of-priority setting unit 124 sets an order of priority for right-of-way. Specifically, the order of priority is a resource for deciding the order of passage through a restricted area. The order of priority is data that is set for each of the restricted areas. For example, the robot 200 with the No. 1 order of priority can enter the restricted area. When a plurality of right-of-ways is granted for one restricted area, the order of priority is set as No. 1, No. 2, and so on, in accordance with the number of robots that have right-of-ways. The robot with the highest order of priority is set to order of priority No. 1. The robots 200 pass through the restricted area in accordance with their orders of priority. The order-of-priority setting unit 124 assigns the order of priority thereof at the timing when the right-of-way is granted. That is to say, the robot 200 that reaches the right-of-way granting position is granted the order of priority along with the right-of-way.

The updating unit 125 updates the order of priority. When the robot 200 with the order of priority No. 1 passes through the restricted area, the right-of-way and the order of priority thereof are revoked. The updating unit 125 raises the order of priority of the remaining robots each by 1. Accordingly, when the right-of-way of the first robot 200 is cancelled, the order of priority of the second robot is raised to No. 1, and the order of priority of the third robot 200 is raised to No. 2. The updating unit 125 raises the order of priority at the timing of the right-of-way granting unit 123 cancelling the right-of-way. The robots 200 that have been granted the right-of-way can pass through the restricted area in order, in accordance with the order of priority.

The communication unit 140 transmits various types of data and signals to each of the robots 200. For example, when a robot 200 moves to a position just short of a restricted area, data regarding the right-of-way and the order of priority is transmitted to that robot 200. Further, the updating unit 125 transmits updated orders of priority to each of the robots 200. Each of the robots 200 is in standby just short of the restricted area when its own order of priority is No. 2 or lower. The robot 200 of which the order of priority has become No. 1 then enters the restricted area. For example, the order-of-priority setting unit 124 can grant order of priority at

the timing when a right-of-way is granted. The order-of-priority setting unit 124 grants orders of priority to the robots 200 in the order in which they arrive near the restricted area. Further, the order-of-priority setting unit 124 may set the order of priority based

on the transported item information, task information, and so forth. For example, the order of priority is updated such that a robot 200 transporting a transported item that should be transported with priority can pass through the restricted area with priority. A case will be described below with reference to in FIG. 3, in which the robot 200A arrives at waypoint WP2, which is a right-of-way granting position, and then the robot 200B arrives at waypoint WP10, which is a right-of-way granting position. Assumption will be made here that the robot 200A is transporting a normal transported item, and that the robot 200B is transporting a priority transported item that is to be transported with priority over the transported item being transported by the robot 200A. First, the robot 200A arrives at waypoint WP2 in a state in which none of the

robots 200A to 200C has been granted right-of-way or order of priority. The right-of-way granting unit 123 grants right-of-way to the robot 200A. Further, the order-of-priority setting unit 124 sets the order of priority of the robot 200A to No. 1. Assumption will be made that the robot 200B then arrives at the waypoint WP10 before the robot 200A enters the restricted area RA1. At this time, the right-of-way granting unit 123 grants right-of-way to the robot 200B, and also, the order-of-priority setting unit 124 sets the order of priority of the robot 200B to the No. 1. The updating unit 125 then updates the order of priority of the robot 200A from No. 1 to No. 2. In other words, the order of priority of the robot 200A is lowered by 1. Thus, the order-of-priority setting unit 124 performs interruption processing

such that the robot 200B, which is transporting a priority transported item, can pass through the restricted area RA1 before the robot 200A. Note that interruption processing refers to processing that allows a robot that has been granted right-of-way later to pass through a restricted area before a robot that has been granted right-of-way earlier. Here, the order-of-priority setting unit 124 defines a robot that has already been granted right-of-way as a grant-imparted robot. Accordingly, the interruption processing means granting a higher order of priority to a robot that is newly granted right-of-way, than to a grant-imparted robot.

When the order-of-priority setting unit 124 performs the interruption processing, the updating unit 125 lowers the order of priority of the grant-imparted robot 200A, which had been set to No. 1, to No. 2. Thus, the robot 200B transporting the priority transported item passes through the restricted area RA1 along the path PH2. At this time, the robot 200A has the No. 2 order of priority and is therefore in standby just short of the restricted area RA1. That is to say, the robot 200A is stopped at a position between the boundary line of the restricted area RA1 and the non-restricted area FA1, and waypoint WP2. Although the robot 200A has right-of-way, the order of priority thereof is No. 2, and accordingly cannot enter the restricted area RA1.

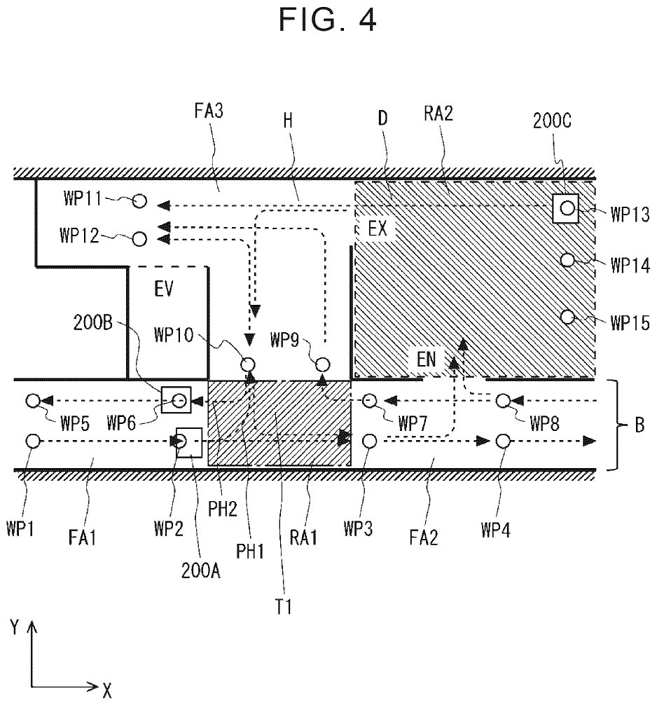

As illustrated in FIG. 4, when the robot 200B passes through the restricted area RA1, the updating unit 125 cancels the right-of-way of the robot 200B, and also revokes the order of priority. The updating unit 125 then raises the order of priority of the robot 200A from No. 2 to No. 1. Thus, the robot 200A enters the restricted area RA1.

At the timing of the robot 200A entering the restricted area RA1, the robot 200B has moved to the vicinity of waypoint WP6 in the non-restricted area FA1. In other words, the robot 200A has not yet entered the restricted area RA1 as long as the robot 200B still remains in the restricted area RA1. Accordingly, the robot 200A can pass through the restricted area RA1 along the path PH1 without coming face to face with or interfering with the robot 200B. Thus, the robot 200B can transport the priority transported item with priority. Further, the robots 200 can move efficiently, thereby suppressing reduction in the efficiency of carrying out tasks as a whole.

Further, in a situation in which the robot 200A has already entered the restricted area RA1 when the robot 200B arrives at the right-of-way granting position, the order of priority of the robot 200B will be next to that of the robot 200A. That is to say, when the robot 200A is already passing through the restricted area RA1, the interruption processing is disabled.

Note that the order-of-priority setting unit 124 can set the order of priority based on the transported item information. For example, the order of priority can be set based on the type and size of the transported item. Alternatively, the order-of-priority setting unit 124 can set the order of priority based on robot information, task information, or the like. That is to say, the order-of-priority setting unit 124 sets a high order of priority to the robot 200B such that the robot 200B that arrives at the right-of-way granting position later can pass with priority. The updating unit 125 then lowers the order of priority of the robot 200A. Thus, the robot 200B arriving at the right-of-way granting position later can pass through the restricted area RA1 ahead of the robot 200A.

For example, the order-of-priority setting unit 124 sets the order of priority in the task information such that the order of priority of a robot currently transporting a transported item is higher than the order of priority of a robot that has completed the transporting. The order of priority of the robot 200 currently carrying out a task is set higher than the order of priority of the robot 200 not currently executing a task. Alternatively, the order-of-priority setting unit 124 may set the order of priority in accordance with the priority of the task. The order-of-priority setting unit 124 sets a high order of priority to a robot that is performing a task with a high priority. Priorities are set based on urgency and importance of tasks.

For example, the order-of-priority setting unit 124 may decide the priority or the order of priority in accordance with the type of transported item, the type of task, the time of day, the congestion status of the facility, and so forth. Data that indicates priority may be assigned to each task or to each transported item. Alternatively, the robot itself may be assigned a priority. Additionally, a robot that is called up by an emergency call or the like may be assigned the highest priority. Also, a task of moving to a charger for charging may have a low order of priority. Also, the order of priority may be different between outbound to a destination point, and returning inbound. The order of priority may be set in accordance with actions taken by the robot. Priority may be classified into multiple levels such as on a scale of 1 to 5 or the like, or may be set as a score or the like using various types of data. When the priorities are the same, the priority is set in the order in which the right-of-way was granted.

The priority is set for the robot 200 based on task information, transported item information, robot information, and so forth. The order-of-priority setting unit 124 then compares the priorities of the right-of-way grant-imparted robots with those of the robots to which right-of-ways will be newly granted, and sets the order of priority accordingly. For example, a robot carrying out a high priority task will be given a higher order of priority. Also, when a deadline for delivering the transported item is set in the transported item information, a higher order of priority may be set for a robot with a shorter time until the arrival deadline, based on the deadline. The order of priority can be set based on a real-time task management status in the task management unit. The order of priority may be variable in accordance with a task to be carried out by a robot 200 that has been newly granted right-of-way. Specifically, the order-of-priority setting unit 124 may determine whether to perform interruption processing by comparing the task that has been newly granted to the robot 200, with the tasks of the grant-imparted robots.

Tasks that require a right-of-way are not limited to transporting tasks, and may also include cleaning tasks and so forth. In other words, passage when a right-of-way is granted includes a temporary stay. Accordingly, when a cleaning task is assigned to a robot, the robot cannot enter the restricted area to carry out the cleaning task until the robot 200 is given right-of-way.

Also, priorities may be set in accordance with the congestion status of the facility. For example, the management device 100 may determine the degree of congestion based on images taken by the camera 500 or the like. A high order of priority may be set for a robot 200 of which the destination point is a highly congested location. Alternatively, a low order of priority may be set for a robot 200 of which the destination point is a highly congested location.

Further, the right-of-way granting unit 123 cancels the right-of-way of the robot 200 that has exited the restricted area. The order-of-priority setting unit 124 then cancels the setting of the order of priority for the robot 200 of which right-of-way has been cancelled. Alternatively, the right-of-way and the order of priority settings may be cancelled after a certain time has elapsed after entering the restricted area.

Also, in a state in which right-of-ways have been set to multiple robots, and then right-of-way is granted to a new robot, the order of priority can be set to any value. An example will be described in which right-of-ways are set for two robots 200A and 200B, and then right-of-way is set for a third robot 200C.

First, it is assumed that the robot 200A and the robot 200B are in right-of-way grant-imparted states, with the robot 200A having order of priority of No. 1, and the robot 200B having order of priority of No. 2. Then, when the robot 200C is newly granted right-of-way, the robot 200C can be given the order of priority of No. 1. In this case, the updating unit 125 updates the order of priority of the robot 200A to No. 2 and the order of priority of the robot 200B to No. 3.

Alternatively, in a state in which the robots 200A and 200B are already grant-imparted their right-of-ways, and then the robot 200C is newly granted right-of-way, the robot 200C may be given the order of priority of No. 2. The updating unit 125 updates the order of priority of the robot 200B to No. 3. In other words, the order of priority of the robot 200A remains at No. 1 and is not updated.

Furthermore, in a state in which the robots 200A and 200B are already grant-imparted their right-of-ways, and then the robot 200C is newly granted right-of-way, the robot 200C may be given the order of priority of No. 3. In other words, the order of priority of the robot 200A remains at No. 1 and is not updated, and the order of priority of the robot 200B remains at No. 2 and is not updated. Also, when granting right-of-ways to multiple robots at once, the order-of-priority setting unit 124 or the updating unit 125 may reshuffle the orders of priority of all of the robots.

At least one restricted area may have a set number of robots that can pass through at the same time. For example, in FIG. 3, the restricted area RA2 is a standby location for loading and unloading transported items. The restricted area RA2 includes three standby spots, which are waypoints WP13, WP14, and WP15, respectively. In this case, three robots 200 can pass through at the same time. Alternatively, four or more robots may be allowed to pass through. Also, when a high order of priority is assigned to a robot 200 to which right-of-way is to be newly granted, the order of priority and right-of-way of a robot 200 with a low order of priority may be cancelled.

Also, when a plurality of the restricted areas is set on a map, the order of priority is set to be different for each of the restricted areas. That is to say, when there are multiple restricted areas, rules for deciding the order of priority may be different for each of the restricted areas. For example, in FIG. 3, in the restricted area RA2 corresponding to the loading and unloading location, the order-of-priority setting unit 124 sets priorities in accordance with the type and importance of the transported items. In the restricted area RA1 in the passageway, the order-of-priority setting unit 124 sets orders of priority in accordance with the type of robot. For example, the order-of-priority setting unit 124 sets a high order of priority to a robot that can move quickly.

Also, orders of priority may be set for each of the robots in one or more restricted areas. In another one or more restricted areas, orders of priority may be set for each type of task, such as transporting tasks, cleaning tasks, security tasks, and so forth. In another one or more restricted areas, orders of priority may be set in accordance with the type of transported item.

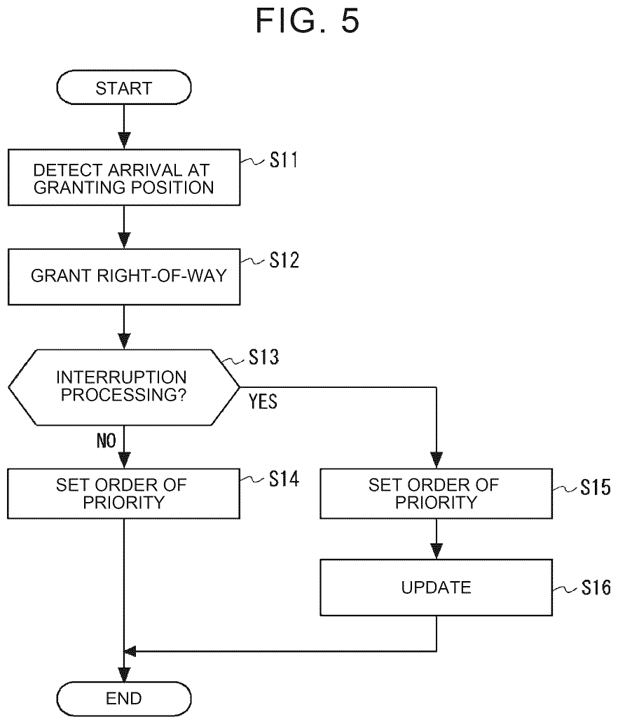

A management method using the management device 100 will be described with reference to FIG. 5. FIG. 5 is a flowchart showing the management method. First, the management device 100 detects that the robot 200 has arrived at the right-of-way granting position (S11). The right-of-way granting unit 123 grants right-of-way to the robot 200 (S12). The order-of-priority setting unit 124 then determines whether to perform interruption processing (S13). For example, the order-of-priority setting unit 124 determines whether to perform interruption processing, based on the transported item information and the task information.

When interruption processing is not to be performed (NO in S13), the order-of-priority setting unit 124 sets an order of priority for the robot 200 (S14). Here, the order-of-priority setting unit 124 sets the lowest order of priority to the robot that has been newly granted right-of-way. For example, when N (where N is an integer equal to or greater than 0) robots 200 have been granted right-of-ways, the order of priority of the robot 200 that has been newly granted right-of-way will be (N+1).

When the interruption processing (YES in S13), the order-of-priority setting unit 124 sets an order of priority for the robot 200 (S15). Here, the order-of-priority setting unit 124 sets a higher order of priority to the robot newly granted with right-of-way than at least one or more robots that are already grant-imparted. For example, when M (where M is an integer equal to or greater than 1) robots 200 are granted right-of-ways, the order of priority of a robot 200 that has been newly granted right-of-way will be M or smaller. The updating unit 125 then updates the order of priority (S16). The updating unit 125 lowers the orders of priority of the grant-imparted robots and that have been interrupted by the robot that has been newly granted right-of-way.

For example, it is assumed that priority is granted to each task. The order-of-priority setting unit 124 compares the task priority of the grant-imparted robot 200 with the task priority of a robot 200 that has been newly granted right-of-way. When the task priority of the robot that has been newly granted right-of-way is lower than the priority of the right-of-way grant-imparted robot, the order-of-priority setting unit 124 determines in S13 that interrupt processing will not be performed. When the task priority of the robot that has been newly granted right-of-way is higher than the priority of the right-of-way grant-imparted robot, the order-of-priority setting unit 124 determines in S13 that interrupt processing will be performed.

Thus, the management system 1 can give priority to carrying out important tasks or tasks with high urgency. The management system 1 enables the robots 200 to move efficiently.

The map data according to the present embodiment has waypoints associated with positions or areas on the map. The map data may also include settings for actions that the moving bodies take in accordance with the waypoints. The map data may have set therein traveling section information in which whether a moving body can pass through, or priority thereof, is set.

The system according to the present embodiment is a system for managing a plurality of moving bodies, and waypoints are set in association with positions or areas on a map. Waypoints have attributes set thereto. Also, actions to be taken by the moving bodies may be set at the waypoints. The map may have set therein traveling section information in which whether a moving body can pass through, or priority thereof, is set.

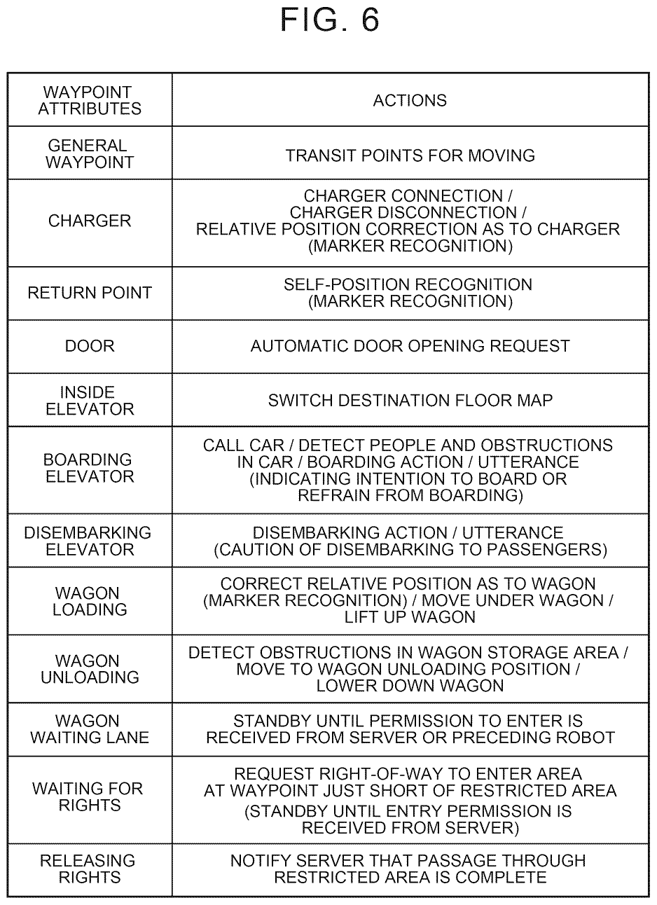

FIG. 6 is a table showing attributes of waypoints and actions associated with the attributes. In FIG. 6, waypoint attributes of general waypoint, charger, return point, door, inside elevator, boarding elevator, disembarking elevator, wagon loading, wagon unloading, wagon waiting lane, waiting for rights, and releasing rights, are registered. It should be noted that two or more attributes may be granted to one waypoint. Specifically, in addition to the general waypoint attribute, one or more other attributes may be given.

General waypoints serve as transit points for moving in route planning. The robot 200 passes over the general waypoint and moves autonomously toward the next waypoint. Charger indicates a location where the charger for the robot 200 is installed. When remaining charge of the battery falls to or below a certain value, the robot 200 moves, with the waypoint of the charger as the destination point thereof. When the robot 200 arrives at the waypoint of the charger, the robot 200 performs relative position correction. For example, a marker is attached to the charger, and a camera of the robot 200 captures an image of the marker in order to correct the relative position. The robot 200 is then connected to the charger and is charged. When charging is complete, the robot 200 is detached from the charger.

Return point corresponds to the position where a marker for self-position recognition is provided. For example, a marker is set on a wall or the like, and upon arriving at a waypoint that is the return point, the robot 200 takes an image of the marker with the camera thereof. The robot 200 then finds the relative position of the robot with respect to the marker, based on the image of the marker that is captured. The position of the marker on the map is known, and accordingly the robot 200 estimates its own position from the relative position of the robot with respect to the marker. Thus, estimation error of its own position accumulated by odometry can be corrected.

Door corresponds to a position at which the robot 200 transmits a signal requesting an automatic door to be opened. Alternatively, the door corresponds to a position where the robot is in standby until the automatic door opens. Inside the elevator corresponds to a position inside an elevator car, and is a position at which the robot 200 stops while the elevator is ascending or descending. At this position, the robot 200 switches the floor map to that of a destination floor.

Boarding elevator corresponds to an elevator boarding and disembarking position. In other words, this is equivalent to a position at which the robot is in standby for the elevator. Upon arriving at the boarding elevator waypoint, the robot 200 calls the car and detects people and obstructions inside the car. When there is space in the elevator car, the robot 200 performs a boarding action. When there is no space in the elevator car, the robot 200 utters its intent to refrain from boarding. Disembarking elevator corresponds to the elevator boarding and disembarking position. That is to say, upon arriving at the disembarking elevator waypoint, the robot 200 utters a caution to people therearound before disembarking.

Wagon loading corresponds to a location where the robot is loaded with a wagon serving as the accessory unit 700 illustrated in FIG. 1. Upon the robot 200 arriving near a wagon loading waypoint, the robot 200 captures an image of a marker provided on the wagon with the camera thereof. Then, based on the image of the marker that is captured, the robot 200 determines its relative position with respect to the wagon. After correcting the relative position, the robot 200 moves under and lifts up the wagon. Wagon unloading corresponds to a location where the robot unloads the wagon serving as the accessory unit 700 illustrated in FIG. 1. Upon arriving near the wagon unloading waypoint, the robot 200 uses a sensor to detect whether there are any obstructions in the location where the wagon is to be unloaded. When there are no obstructions, the robot moves to the unloading position and lowers down the wagon. Wagon waiting lane corresponds to a location where multiple wagons are lined up. The wagon waiting lane waypoint is included in a restricted area where the number of robots that can enter is set, for example. The robot is in standby until receiving permission to enter from a server, which is the management device 100, or from a preceding robot 200.

Waiting for rights corresponds to a boundary portion of a restricted area and a non-restricted area. The waiting for rights waypoint is located just short of the restricted area. Upon arriving at the waiting for rights waypoint, the robot 200 requests a right-of-way from the management device 100.

Releasing rights corresponds to a boundary portion between a restricted area and a non-restricted area. The releasing rights waypoint is located within a non-restricted area. Upon arriving at the releasing rights waypoint, the robot 200 notifies the server, which is the management device 100, that passage thereof has been completed. The attributes of waypoints are not limited to the above examples, as a matter of course. Some of the above may not be present, and other waypoints may be present.

The management device 100 and the robot 200 may use machine learning models such as deep learning or the like for route planning and drive control. Further, machine learning models, such as deep learning models like recurrent neural networks (RNNs), convolutional neural networks (CNNs), and so forth, may be used for detecting surrounding objects, as well.

Also, some or all of the processing performed by the robot 200, the management device 100, and so forth, described above, can be realized as a computer program. Such a program can be stored and provided to a computer using various types of non-transitory computer-readable media. Non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical discs), compact-disc read-only memory (CD-ROM), CD-R, CD-R/W, and semiconductor memory (e.g., mask ROM, programmable ROM (PROM), erasable PROM (EPROM), flash ROM, and random access memory(RAM)). The program may also be supplied to the computer by various types of transitory computer-readable media. Examples of transitory computer-readable media include electrical signals, optical signals, and electromagnetic waves. A transitory computer-readable medium can supply the program to the computer via a wired communication path such as an electric wire, an optical fiber, or the like, or via a wireless communication path.

Note that the present disclosure is not limited to the above-described embodiment, and can be modified as appropriate without departing from the spirit and scope thereof.

What is claimed is:

1. A management system equipped with a server that manages a plurality of autonomous moving bodies that moves within a facility, the management system comprising:
a map information storage unit that stores map information indicating a map of the facility;
an area setting unit that sets a restricted area on the map to restrict passage of the autonomous moving bodies;
a right-of-way granting unit that grants, to the autonomous moving bodies, a right-of-way that enables the autonomous moving bodies to pass through the restricted area;
an order-of-priority setting unit that sets an order of priority for passage by the autonomous moving bodies granted the right-of-way by the right-of-way granting unit; and
an updating unit that, when the right-of-way is newly granted to one autonomous moving body, updates the order of priority already granted.

2. The management system according to claim 1, further comprising a task management unit that manages tasks carried out by each of the autonomous moving bodies, wherein the order of priority is made to be variable in accordance with the task to be carried out by the autonomous moving body to which the right-of-way is newly granted.

3. The management system according to claim 1, wherein, when an already-set autonomous moving body for which the right-of-way is already set is passing through the restricted area corresponding to the right-of-way, the order of priority of the autonomous moving body that is set is maintained.

4. The management system according to claim 1, wherein
a plurality of the restricted area is set on the map, and
the order of priority is set to differ in accordance with the restricted area.

5. A management method for managing a plurality of autonomous moving bodies that moves within a facility, using a management device that includes
a map information acquisition unit that acquires map information indicating a map of the facility, and
an area setting unit that sets a restricted area on the map to restrict passage of the autonomous moving bodies,
the management method comprising:
granting, to the autonomous moving bodies, a right-of-way that enables the autonomous moving bodies to pass through the restricted area;
setting an order of priority for passage by the autonomous moving bodies to which the right-of-way is granted; and
updating the order of priority already granted when the right-of-way is newly granted to one autonomous moving body.
